(19) United States
(12) Patent Application Publication
(10) Pub. No.: US 2011/0085194 A1
(43) Pub. Date: Apr. 14, 2011

(54) LOG INFORMATION PROCESS DEVICE, IMAGE FORMATION APPARATIS, AND LOG INFORMATION PROCESSING METHOD

(75) Inventor: Kanako Asari, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/862,132

(22) Filed: Aug. 24, 2010

Related U.S. Application Data
(60) Provisional application No. 61/249,664, filed on Oct. 8, 2009.

(30) Foreign Application Priority Data
Jun. 22, 2010 (JP) 2010-141217
Jul. 1, 2010 (JP) 2010-150689

(51) Int. Cl. G06K 15/00

(52) U.S. Cl. 358/1.14

(57) ABSTRACT

A log information processing device includes an authentication unit, a memory, and a control unit. The authentication unit authenticates a user. The memory stores a first log information about a job which is requested by the user. The control unit replaces a first data included in the first log information with a second data to form a second log information. The second data is related to the first data. The control unit instructs to transmit the second log information to an external apparatus.

### CROSS-REFERENCE TO RELATED APPLICATION

This application is based upon and claims the benefit of priority from: U.S. provisional application 61/249,664, filed on Oct. 8, 2009, the entire contents of which are incorporated herein by reference.

This application is also based upon and claims the benefit of priority from the Japanese Patent Application No. 2010-141217, filed on Jun. 22, 2010, the entire contents of which are incorporated herein by reference.

This application is also based upon and claims the benefit of priority from the Japanese Patent Application No. 2010-150689, filed on Jul. 1, 2010, the entire contents of which are incorporated herein by reference.

### FIELD

Embodiments described herein relate generally to a log information processing device, an image formation apparatus, and a log information processing method.

### BACKGROUND

There is a log information management system for transmitting log information (information about amount of printing, printing information, and the like) of a job such as printing and scanning to a management server when the job is executed by an image formation apparatus. The management server uses the log information to calculate the amount of printing and the charged amount.

The log information management system transmits all the log information obtained by the image formation apparatus to the management server. When it is an object for the management server to use the log information to calculate the amount to be charged, the log information management system transmits, to the management server, log information including names of documents and names of those executing jobs which are excluded from the calculation of the amount to be charged, for example. Therefore, when log information is leaked, there is a possibility that a large amount of information is leaked.

Alternatively, a log information management system may be configured such that items to be recorded are selected when the log information is obtained, and only the information about the selected items is transmitted to the management server. However, unless such kind of log information management system has a transmission history, the management server cannot obtain only the log information of the non-selected items after the log information is obtained. More specifically, the log information management system cannot provide the log information that is determined to be unnecessary when the log information is obtained but is later determined to be necessary. Further, in a case where the management server manages the log information in a certain format, it is necessary to change the format when the items of the log information are changed.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram illustrating a log information management unit of the image formation apparatus according to a first embodiment;

FIG. 2 shows an example of a log information stored in the memory;

FIG. 3 shows an example of a log information in which data of some items of the log information shown in FIG. 2 is replaced with related data;

FIG. 4 shows an example of a log information in which data of some items of the log information shown in FIG. 2 is replaced with unrelated data;

FIG. 5 is a flow chart of processing for transmitting a log information;

FIG. 6 is a flow chart of processing for transmitting a log information according to a second embodiment;

FIG. 7 shows an example of a conversion table stored in the memory;

FIG. 8 shows an example of the conversion table stored in the memory;

FIG. 9 shows an example of data converted based on the conversion table of FIG. 8; and

FIG. 10 shows an example of the conversion table stored in the memory.

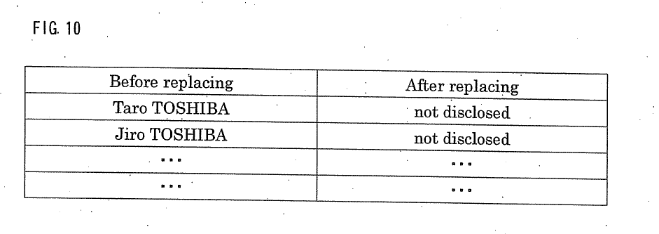

### DETAILED DESCRIPTION

Embodiments according to the invention will be hereinafter described with reference to the drawings.

According to one aspect of the invention, a log information processing device, includes an authentication unit to authenticate a user; a memory to store a first log information about a job which is requested by the user; and a control unit to replace a first data included in the first log information with a second data to form a second log information, the second data is related to the first data, and to instruct to transmit the second log information to an external apparatus.

According to another aspect of the invention, an image formation apparatus, includes an authentication unit to authenticate a user; an execution unit to execute a job to form an image, the job being requested by the user; a memory to store a first log information about the job; and a control unit to replace a first data included in the first log information with a second data to form a second log information, the second data is related to the first data, and to instruct to transmit the second log information to an external apparatus.

According to another aspect of the invention, a log information processing method, includes authenticating a user; storing a first log information about a job which is requested by the user; replacing a first data included in the first log information with a second data to form a second log information, the second data being related to the first data; and transmitting the second log information to an external apparatus through a network.

### Description of the First Embodiment

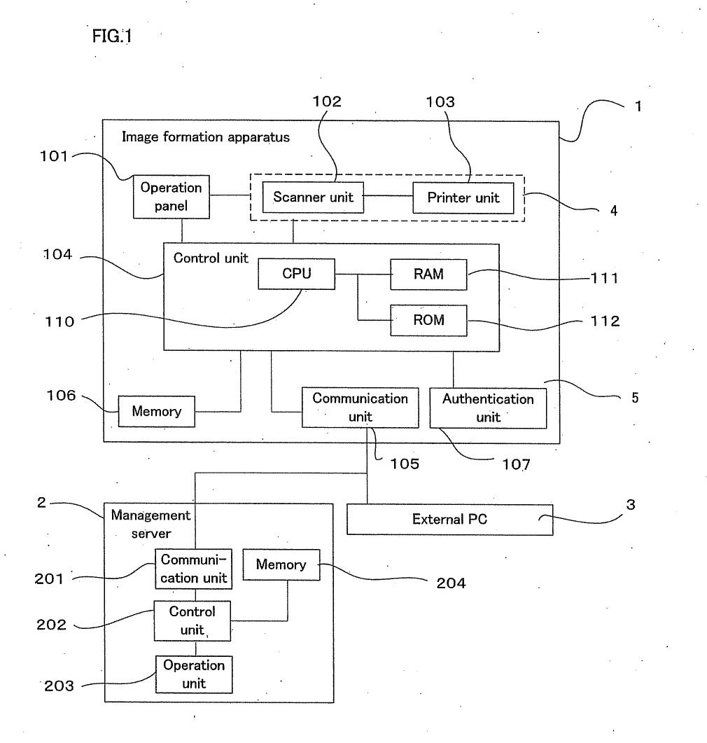

A first embodiment will be described with reference to FIGS. 1 to 4. In the embodiment, the image formation apparatus has functions as a log information processing unit.

FIG. 1 is a block diagram showing a log information management unit of the image formation apparatus.

The image formation apparatus 1 is connected to a management server 2 and an external PC 3 via a network.

The image formation apparatus 1 includes an operation panel 101, a scanner unit 102, a printer unit 103, a control unit 104, a communication unit 105, a memory 106, and an authentication unit 107.

The operation panel 101 is a user interface to which instructions given by a user is input. The operation panel 101 has hard keys such as numeric keys and touch keys on a display unit of a display device embedded in a touch panel so as to receive instructions given by the user.

The scanner unit 102 converts an image on an original document into image data. The printer unit 103 forms the image on the original document onto a recording medium. The scanner unit 102 and the printer unit 103 provide an execution unit 4 for executing a job based on an instruction given by a user.

The control unit 104 includes a CPU (Central Processing Unit) 110, a RAM (Random Access Memory) 111, and a ROM (Read Only Memory) 112. The CPU 110 is a processor for controlling the entire control unit 104. The RAM 111 is a memory for temporarily storing work data and storing reference data. The ROM 112 is a nonvolatile memory. The ROM 112 stores control data and control programs for controlling the image formation apparatus 1. The CPU 110 executes various kinds of processing and various kinds of functions based on the control programs stored in the ROM 112. The control unit 104 performs control for transmitting the log information of the image formation apparatus 1 to the management server 2. In the first embodiment, the CPU 110 is used as a processor. However, the type of processor is not limited thereto.

The communication unit 105 controls data communication via the network. The image formation apparatus 1 communicates with the management server 2 and an external personal computer (PC) 3 via the communication unit 105.

The memory 106 stores log information of a job performed by a user. The authentication unit 107 obtains authentication data of the user such as ID and password, and authenticates the user. In addition, the authentication data may include biometrics authentication data. ID (individual name, name of department to which a user belongs) obtained by the authentication unit 107 may be included in the log information and stored in the memory 106, for example. The authentication unit 107 is achieved with a card reader for reading information stored in an IC card possessed by a user, for example. Alternatively, the operation panel 101 may have the functions of the authentication unit 107. In the case, a user is authenticated by inputting an ID and a password to the operation panel, for example.

A log information processing unit 5 is provided by the authentication unit 107, the memory 106, and the control unit 104, which relate to the processing of log information, among the constituent elements of the image formation apparatus 1. The log information processing unit 5 may include the communication unit 105.

Subsequently, the management server 2 will be described. The management server 2 is connected to the image formation apparatus 1 via a network, not shown. The management server 2 includes a communication unit 201, a control unit 202, an operation unit 203, and a memory 204. The communication unit 201 receives log information transmitted from the image formation apparatus 1. The communication unit 201 stores the received log information to the memory 204 according to control performed by the control unit 202.

When a service engineer sets a later-described log information disclosure level 3, the service engineer uses the operation unit 203, for example. The control unit 202 controls each constituent element of the management server 2.

The external PC 3 is connected to the image formation apparatus 1 via the network. A driver of the image formation apparatus 1 is installed to the external PC 3, a print instruction of a document generated on the external PC 3 can be transmitted to the image formation apparatus 1 via the network.

When the image formation apparatus 1 transmits log information to the management server 2, the log information processing unit 5 according to the first embodiment does not transmit the original log information stored in the memory 106 of the image formation apparatus 1 to the management server 2. The log information processing unit 5 can change, according to the log information disclosure level set by the service engineer, the log information to be transmitted to the management server 2.

Subsequently, a method for changing the log information to be transmitted from the image formation apparatus 1 to the management server 2 according to the log information disclosure level will be described.

The service engineer uses the management server 2 to set the log information disclosure level to the image formation apparatus 1. When the log information disclosure level is set by the management server 2, the control unit 104 of the image formation apparatus 1 controls the log information processing unit 5 so that the items of target log information stored in the memory 106 are edited and transmitted to the management server 2 according to the log information disclosure level.

In the first embodiment, the setting of the log information disclosure level can be selected from among “disclose all”, “disclose replaced data”, and “not disclose”, for example. When “disclose all” is selected, the image formation apparatus 1 transmits all the stored log information to the management server 2. When “disclose replaced data” is selected, the image formation apparatus 1 replaces some items of the stored log information with other data and transmits the log information to the management server 2. When “not disclose” is selected, the image formation apparatus 1 does not transmit the log information to the management server 2.

The operation of “disclose replaced data” will be described further in detail. First, the service engineer operates the operation unit 203 of the management server 2 so as to specify items of the log information to be replaced. When the control unit 202 recognizes that the items to be replaced are specified, the control unit 202 instructs the communication unit 241 to transmit the items to the image formation apparatus 1. The communication unit 105 of the image formation apparatus 1 receives a notification including the items specified for replacement. The control unit 104 of the image formation apparatus 1 recognizes the items of the log information that are specified for replacement. Then, when “disclose replaced data” is selected, the control unit 104 of the image formation apparatus 1 replaces data of items specified for replacement with other data.

As described above, every time items needed as log information changes, the service engineer can use the management server 2 to specify the items to be replaced. Alternatively, the service engineer can also use the operation panel 101 of the image formation apparatus 1 to set the log information disclosure level and the items to be replaced.

Two kinds of methods can be selected in “disclose replaced data”. In the first method, data of specified items is replaced with data related to original data. In the second method, the specified items are replaced with data not related to the original data. In the same manner as the setting of the items to be replaced and the log information disclosure level, the service engineer uses the operation panel 101 of the image formation apparatus 1 and the management server 2 to set which of the first method and the second method is used.

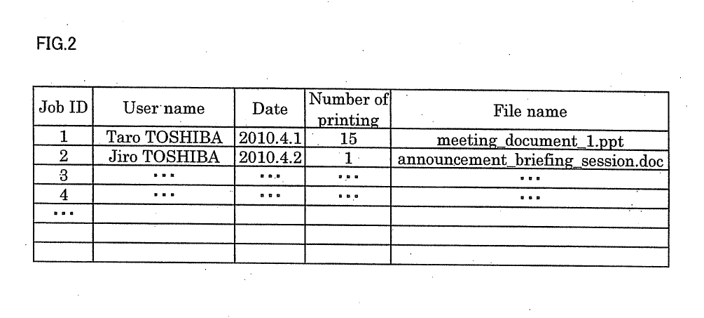

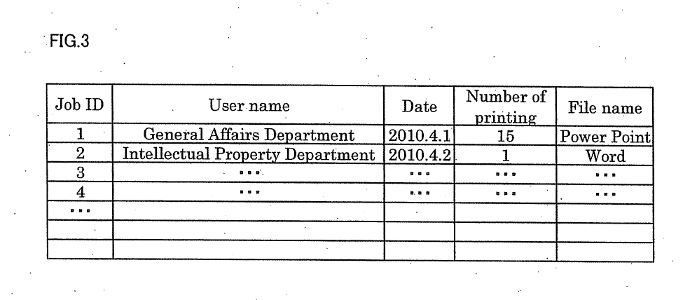

First, the first method will be described. FIG. 2 shows log information stored in the memory 106. FIG. 3 shows an example of log information in which data of some items of the log information shown in FIG. 2 is replaced with related data.

Names in fields of “user name” of FIG. 2 are replaced with names of departments to which the users belong in FIG. 3, respectively. Further, file names in fields of “file name” of FIG. 2 are replaced with names of file formats such as Power Point and Word in FIG. 3, respectively. The data of these replaced items is replaced with data related to the original log information. That is, unlike the original log information (first names and last names of users and file names), the replaced log information does not uniquely identify data. However, the replaced log information (names of departments to which users belong and names of file formats) is data derived from the original log information (first names and last names of users and file names). Therefore, the original log information and the replaced log information are related to each other.

In the specified items, the original log information (such as user names and file names) is replaced with the related data (such as names of departments to which users belong and names of file formats). Accordingly, individual users and files cannot be identified from the log information transmitted from the management server 2. Therefore, a certain level of security can be maintained. In addition, other data related to users and files is transmitted to the management server 2 without any replacement, so that the other data is the same as the log information stored in the memory 106 of FIG. 2. Therefore, the log information can be calculated in any given category.

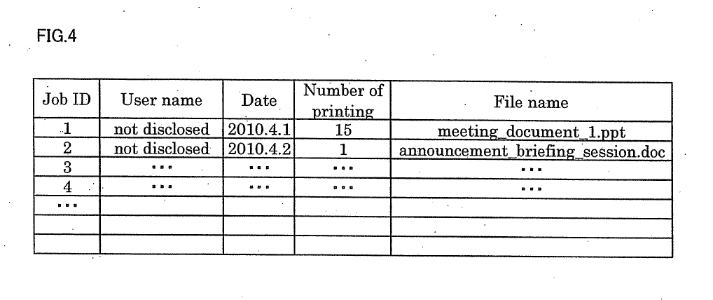

Subsequently, the second method will be described. FIG. 4 is an example of log information in which data of a portion of the log information shown in FIG. 2 is replaced with unrelated data. In FIG. 4, fields of user names are replaced with “not disclose”. As described above, data of the specified items is replaced with data (such as “not disclose”) that are not at all related to the original data (such as first names and last names of users), whereby individual users cannot be identified from the log information transmitted to the management server 2. In other words, the security is enhanced by replacing personal information with other unrelated data. In addition, data of other items is transmitted to the management server 2 without any replacement, so that the other data is the same as the log information stored in the memory 106 of FIG. 2. Therefore, the log information can be calculated in any given category.

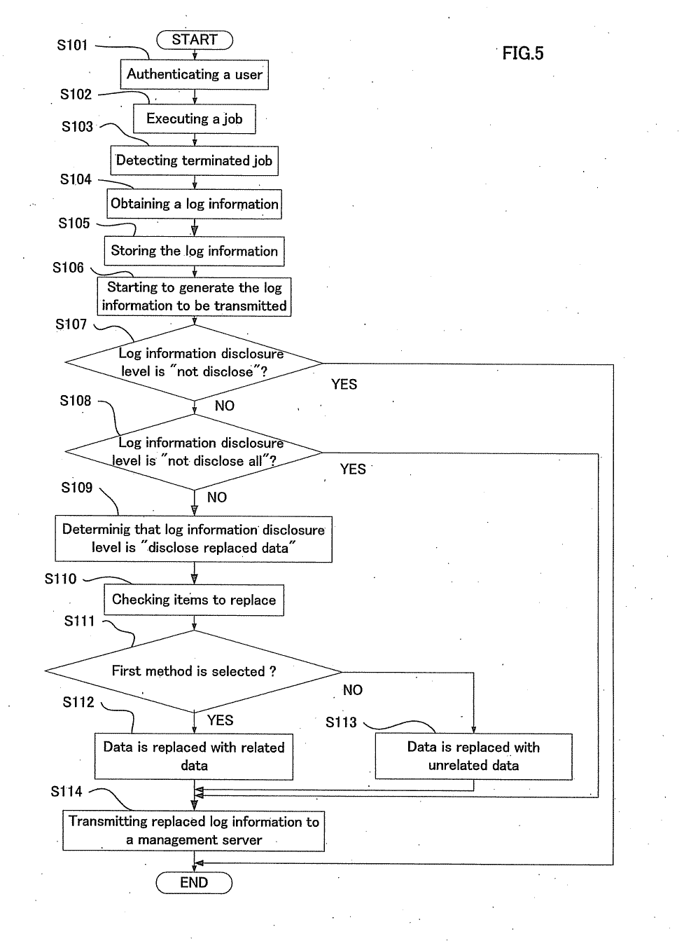

Subsequently, processing for transmitting log information from the image formation apparatus 1 to the management server 2 will be described with reference to FIG. 5.

First, when information about a user of the image formation apparatus 1 is input from the authentication unit 107, the control unit 104 authenticates the user (S101). When the user is authenticated, a job such as printing and scanning is executed (S102). Instructions of the job performed on the image formation apparatus 1 may be given from the operation panel 101 of the image formation apparatus 1, or may be given by a printer driver of the external PC 3 connected to the image formation apparatus 1 via the network.

When the control unit 104 detects that the job performed on the image formation apparatus 1 is terminated (S103), processing for obtaining the log information is subsequently performed (S104). The log information of the terminated job is stored in the memory 106 (S105). Then, the control unit 104 starts generating the log information transmitted to the management server 2 (S106).

The control unit 104 determines whether the log information disclosure level is designated as “not disclose” or not (S107).

When the control unit 104 determines that the log information disclosure level is designated as “not disclose” (YES in S107), the processing is terminated without transmitting the log information to the management server 2. On the other hand, when the control unit 104 determines that the log information disclosure level is not designated as “not disclose” (NO in S107), the control unit 104 determines whether the log information disclosure level is designated as “disclose all” or not (S108).

When the control unit 104 determines that the log information disclosure level is designated as “disclose all” (YES in S108), the control unit 104 reads the log information from the memory 106, and causes the communication unit 105 to transmit the log information to the management server 2 without replacement (S114).

On the other hand, when the control unit 104 determines that the log information disclosure level is not designated as “disclose all” (NO in S108), the control unit 104 determines whether the log information disclosure level is designated as “disclose replaced data” or not (S109). Thereafter, the control unit 104 checks the items to be specified for replacement (S110).

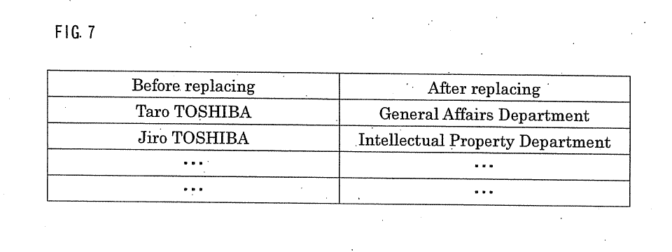

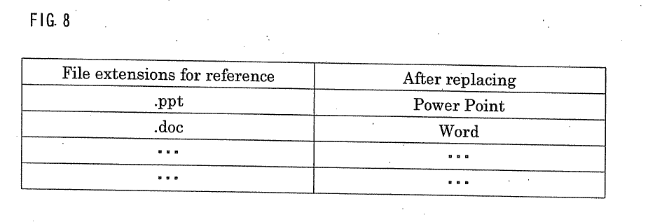

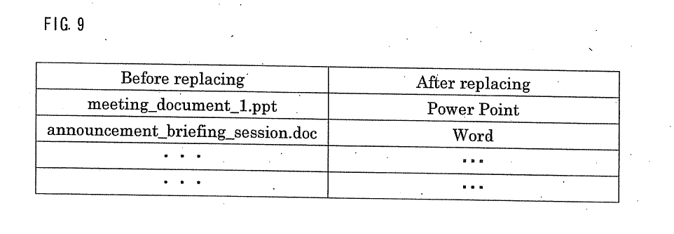

After confirming the items to be specified for replacement in S110, the control unit 104 determines whether the first method (the method for replacing data with related data) is set or not (S111). When the control unit 104 determines that the first method (the method for replacing data with related data) is set (YES in S111), data of the items specified for replacement is replaced with related data (S112). The first names and the last names in fields of user names are respectively replaced with names of departments to which the users belong, for example. Alternatively, file names in fields of file names are replaced with names of file formats. In other words, the control unit 104 references a conversion table as shown in FIG. 7, and replaces a user name “Taro TOSHIBA” with a name of department “General Affairs Department” to which “Taro TOSHIBA” belongs. Likewise, the control unit 104 references a file extension included in a file name, and replaces data using a conversion table as shown in FIG. 8. As a result, the file name “meeting_document_{—}1.ppt” is replaced with a name of file format “Power Point” as shown in FIG. 9. The conversion tables as shown in FIG. 7, FIG. 8 are stored in the memory 106 of the image formation apparatus 1 in advance. As necessary, a service engineer may use the operation unit 203 of the management server 2 and the operation panel 101 of the image formation apparatus 1 to edit the data in these conversion tables. As described above, when the data of the specified items of the log information is replaced with the related data in the log information processing unit 5, the replaced log information is transmitted from the communication unit 105 to the management server 2 (S114).

When the control unit 104 determines that the first method (the method for replacing data with related data) is not set (NO in S111), the control unit 104 determines that the second method (the method for replacing data with unrelated data) is selected. Then, the control unit 104 replaces data of items specified for replacement with unrelated data (S113). The control unit 104 replaces user names with “not disclosed”, for example. At the occasion, the control unit 104 references a conversion table as shown in FIG. 9, and replaces “Taro TOSHIBA” in a field of user name with data “not disclosed”. The conversion table as shown in FIG. 9 is stored in the memory 106 of the image formation apparatus 1 in advance. As necessary, a service engineer may use the operation unit 203 of the management server 2 and the operation panel 101 of the image formation apparatus 1 to edit the data in these conversion tables.

Thereafter, the replaced log information is transmitted from the communication unit 105 to the management server 2 (S114).

In the first embodiment, every time one job is terminated, the log information is transmitted from the image formation apparatus 1 to the management server 2. Alternatively, log information of a plurality of jobs may be transmitted to the management server 2. In the case, after the log information to be transmitted to the management server 2 is generated, the generated log information is stored in the image formation apparatus 1. Alternatively, the management server 2 may transmit a request for transmitting log information with a regular interval to the image formation apparatus 1 to collect the log information from the image formation apparatus 1.

In the first embodiment, the image formation apparatus 1 has only the scanner function and the print function. In addition, the image formation apparatus 1 may have a facsimile function and the like. In such case, in the same manner as the first embodiment, the log information processing unit 5 can process log information obtained by executing the facsimile function, so that data of a portion of the log information is replaced with related data.

According to the first embodiment, when the log information disclosure level may be set to “disclose replaced data”, and log information is transmitted from the image formation apparatus 1 to the management server 2, data of items specified by the service engineer is replaced with other data and is transmitted, whereby the possibility of leaking information can be reduced.

According to the first embodiment, data of specified items is just replaced. Therefore, the number of items of log information neither increases nor decreases. Therefore, in a case where a standardized format is used in the management server 2 to manage log information, it is not necessary to change the standardized format even though the items of the log information are changed. Therefore, the convenience in managing log information can be enhanced.

In the first embodiment, the functions for carrying out the invention are assumed to be recorded in the image formation apparatus 1 and the management server 2 in advance. However, the invention is not limited thereto. The functions for carrying out the invention may be downloaded from the network to the image formation apparatus 1 and the management server 2, for example. Alternatively, the functions for carrying out the invention may be read from a recording medium storing the functions for carrying out the invention, and may be installed on the image formation apparatus 1 and the management server 2. The recording medium may be in any form as long as the recording medium is a medium that can store programs and can be read by the apparatus, such a CD-ROM. Further, the functions obtained by previous installation and downloading may be achieved in cooperation with an OS (Operating System) and the like in the image formation apparatus 1.

### Description of the Second Embodiment

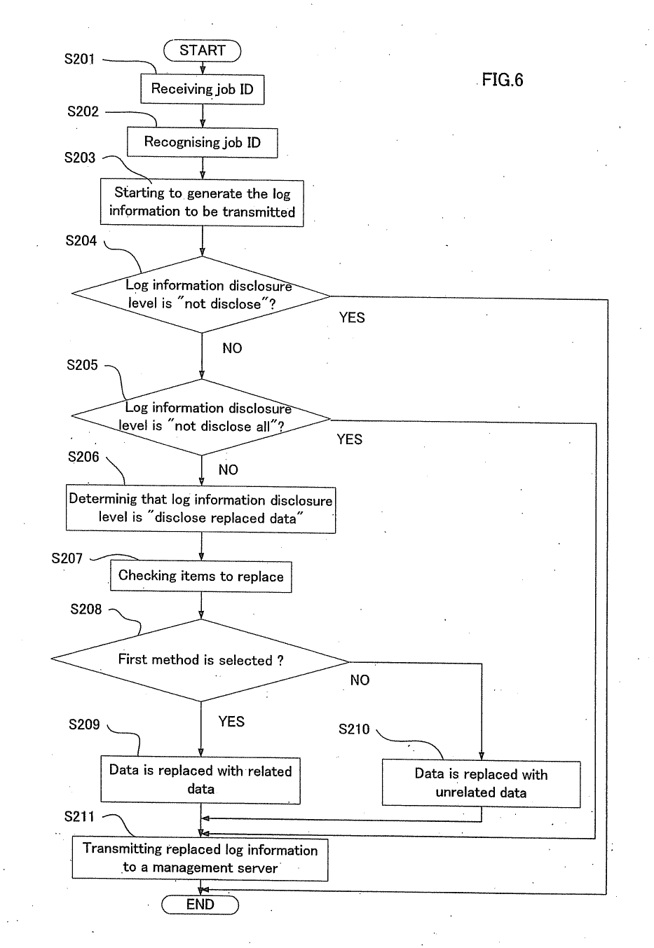

A second embodiment will be described with reference to FIG. 6.

Hereinafter, the same portions as those of the first embodiment are denoted with the same numerals, and only characterizing portions of the second embodiment will be described. In the second embodiment, an administrator who manages log information uses the management server 2 and the external PC 3 connected to the image formation apparatus 1 to request the image formation apparatus 1 to transmit log information. Thereby, the management server 2 can obtain desired log information from the image formation apparatus 1. For example, the image formation apparatus 1 assigns a unique job ID to each job, and stores the job ID and the log information in association with each other. When the management server 2 and the external PC 3 request the image formation apparatus 1 to transmit log information, the management server 2 and the external PC 3 specify a job ID. Thereby, the management server 2 can obtain log information relating to the specified job from the image formation apparatus 1.

When the external PC 3 requests transmission of log information, the log information is not transmitted to the external PC 3 but is transmitted to the management server 2.

The management server 2 and the external PC 3 are any PCs connected to the image formation apparatus 1.

FIG. 6 is a flowchart showing processing performed by any PCs connected to the image formation apparatus 1 so as to request the image formation apparatus 1 to transmit log information.

First, any PCs connected to the image formation apparatus 1 notify a job ID of a job, whose log information is to be obtained, to the image formation apparatus 1. The communication unit 105 of the image formation apparatus 1 receives the job ID (S201). The control unit 104 of the image formation apparatus 1 recognizes the received job ID (S202), and starts generating log information to be transmitted to the management server 2, from log information stored in the memory 106 (S203).

The processing of steps S204 to S211 for generating log information and transmitting the log information to the management server 2 is similar to the processing of steps S107 to S114 in the flowchart of FIG. 4 of the first embodiment.

According to the second embodiment, when the administrator of log information needs log information of any job of the image formation apparatus 1, the administrator can obtain the log information of the desired job by transmitting a request from the management server 2 or the external PC 3 connected to the image formation apparatus 1. Thus, the convenience of the log information management system for the administrator of log information is enhanced.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and a entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A log information processing device, comprising:
an authentication unit to authenticate a user;
a memory to store a first log information about a job which is requested by the user; and
a control unit to replace a first data included in the first log information with a second data to form a second log information, the second data being related to the first data, and to instruct to transmit the second log information to an external apparatus.

2. A log information processing device, comprising:
an authentication unit to authenticate a user;
a memory to store a first log information about a job which is requested by the user; and
a control unit to
obtain a mode, the mode being either of replacing a first data with a second data or replacing the first data with a third data, the first data being included in the first log information, the second data being related to the first data, the third data having no relation with the first data,
replace the first data with the second data or the third data according to the mode to form a second log information, and
instruct to transmit the second log information to an external apparatus.

3. The device of claim 1, further comprising:
a communication unit to communicate with the external apparatus, wherein
the control unit receives an indication indicating item to be replaced in the first log information from the external apparatus, and replace data of the item with other data.

4. The device of claim 4, wherein
the control unit instructs to transmit the second log information to the external apparatus when the job terminates.

5. The device of claim 1, wherein
the control unit instructs to transmit the second log information to the external apparatus if the control unit receives a request to send the second log information from the external apparatus.

6. The device of claim 1, wherein
the memory stores a conversion table, and
the control unit replaces the first data with the second data according to the conversion table.

7. The device of claim 6, further comprising:
a communication unit to communicate with the external apparatus, wherein
the control unit receives an indication to edit the conversion table from the external apparatus, and edits the conversion table.

8. An image formation apparatus, comprising:
an authentication unit to authenticate a user;
an execution unit to execute a job to form an image, the job being requested by the user;
a memory to store a first log information about the job; and
a control unit to replace a first data included in the first log information with a second data to form a second log information, the second data being related to the first data, and to instruct to transmit the second log information to an external apparatus.

9. An image formation apparatus, comprising:
an authentication unit to authenticate a user;
an execution unit to execute a job to form an image, the job being requested by the user;
a memory to store a first log information about the job; and
a control unit to
obtain a mode, the mode being either of replacing a first data with a second data or replacing the first data with a third data, the first data being included in the first log information, the second data being related to the first data, the third data having no relation with the first data,
replace the first data with the second data or the third data according to the mode to form a second log information, and
instruct to transmit the second log information to an external apparatus.

10. The device of claim 8, further comprising:
a communication unit to communicate with the external apparatus, wherein
the control unit receives an indication indicating item to be replaced in the first log information from the external apparatus, and replace data of the item with other data.

11. The device of claim 8, wherein
the control unit instructs to transmit the second log information to the external apparatus when the job terminates.

12. The device of claim 8, wherein
the control unit instructs to transmit the second log information to the external apparatus if the control unit receives a request to send the second log information from the external apparatus.

13. The device of claim 8, wherein
the memory stores a conversion table, and
the control unit replaces the first data with the second data according to the conversion table.

14. The device of claim 13, further comprising:
a communication unit to communicate with the external apparatus,
wherein
the control unit receives an indication to edit the conversion table from the external apparatus, and edits the conversion table.

15. A log information processing method, comprising:
authenticating a user;
storing a first log information about a job which is requested by the user;
replacing a first data included in the first log information with a second data to form a second log information, the second data being related to the first data; and
transmitting the second log information to an external apparatus through a network.

16. A log information processing method, comprising:
authenticating a user;
storing a first log information about a job which is requested by the user;
obtaining a mode, the mode being either of replacing a first data with a second data or replacing the first data with a third data, the first data being included in the first log information, the second data being related to the first data, the third data having no relation with the first data;
replacing the first data with the second data or the third data according to the mode to form a second log information; and
transmitting the second log information to an external apparatus through a network.

17. The method of claim 15, further comprising:
receiving an indication indicating item to be replaced in the first log information from the external apparatus;
wherein
replacing the first data with the second data according to the item.

18. The method of claim 15, wherein
transmitting the second log information to the external apparatus when the job terminates.

19. The method of claim 15, wherein
transmitting the second log information to the external apparatus when receiving a request to send the second log information from the external apparatus.

20. The method of claim 15, wherein
replacing the first data with the second data according to a conversion table.

21. The method of claim 20, further comprising:
receiving an indication to edit the conversion table from the external apparatus; and
editing the conversion table.
